(19) United States
(12) Patent Application Publication
(10) Pub. No.: US 2025/0142397 A1
(43) Pub. Date: May 1, 2025

(54) SHARED MODULATION BASED MULTIPLE ACCESS TECHNIQUE FOR NEXT GENERATION COMMUNICATION SYSTEMS

(71) Applicant: Muhammad Ahsan Naim, Irving, TX (US)

(72) Inventor: Muhammad Ahsan Naim, Irving, TX (US)

(21) Appl. No.: 18/930,510

(22) Filed: Oct. 29, 2024

Related U.S. Application Data
(60) Provisional application No. 63/546,233, filed on Oct. 29, 2023.

(51) Int. Cl. H04W 28/02; H04L 1/00; H04L 27/34

(52) U.S. Cl. CPC H04W 28/0236; H04L 1/0003; H04L 1/0009; H04W 28/0221; H04L 27/3416

(57) ABSTRACT

This disclosure relates generally to coded modulation techniques for use in digital communication systems such as orthogonal frequency division multiplexed multiple access (OFDMA) systems. More particularly, the disclosure relates to methods and apparatus for multilevel coding and decoding. Different receivers coupled to different parallel downlink channels with different channel qualities decode different received signal constellations at different levels of resolution. This allows the overall OFDMA downlink to operate with a significantly higher data rate, thus significantly increasing system level bandwidth efficiency.

### CROSS-REFERENCE TO RELATED APPLICATIONS

This application claims priority under 35 U.S.C. § 119(e) to U.S. Provisional Application No. 63/546,233, filed on Oct. 29, 2023, and titled “SELECTIVE MAPPING OF CODED MULTI-CHANNEL TRANSMISSION,” which is incorporated herein by reference in its entirety.

### BACKGROUND

In recent years, the demand for high-capacity, energy-efficient communication networks have surged dramatically, driven by the proliferation of mobile devices, IoT, and data-intensive applications. Cellular networks, WiFi systems, satellite communication, and cable networks all face unprecedented levels of data traffic and increased user expectations for speed, quality, and reliability. As users increase in both number and variety, each with unique data needs and transmission environments, network providers are tasked with maximizing the efficiency of available spectrum and power resources to meet these demands. Current communication systems face one or more of the following challenges:
Spectrum and Power Constraints: Traditional communication systems often operate with independent data channels, whereby each user or device is allocated its own unique modulation symbol. This method, while straightforward, can be inefficient in crowded network conditions, especially for spectrum-limited environments like mobile cellular and satellite communication. The use of independent channels results in increased power usage and spectrum occupancy, particularly as systems transition to higher-capacity standards such as 5G and beyond.
Dynamic Channel Conditions: Network channel quality varies considerably based on physical factors (e.g., obstacles, distance, and user mobility) as well as technical factors (e.g., interference, noise levels). To compensate, systems use modulation and coding schemes (MCS) tailored to each user's channel quality, with lower modulation schemes for users in challenging conditions and higher schemes for those with optimal conditions. While this customization is essential for minimizing errors, it can lead to inefficient resource utilization when multiple users with disparate channel conditions share the same network resources.
Complexity in Handling Diverse User Requirements: Networks must accommodate users with different service levels, latency sensitivities, and data requirements, such as streaming, voice, IoT communications, and fixed wireless. Each type of service demands a specific quality of service, adding layers of complexity to modulation and coding decisions.
Energy Efficiency: As energy consumption becomes a critical design consideration, especially for mobile devices and IoT systems, traditional methods of transmitting data independently to each user result in higher power requirements. The need to improve energy efficiency without compromising data throughput presents a major engineering challenge.

Recent advancements in multi-user and multi-input multi-output (MU-MIMO) configurations, massive MIMO, beamforming, and advanced modulation techniques have laid the groundwork for more sophisticated communication strategies. By using beamforming and spatial multiplexing, systems can serve multiple users over the same frequency resources, effectively increasing capacity. Additionally, adaptive modulation, where modulation schemes adjust to the channel quality in real time, allows networks to operate more flexibly across varying conditions.

However, while these techniques have been essential in managing network congestion and improving efficiency, they often fall short in scenarios with high user density and limited spectrum. These limitations are particularly apparent in systems where a wide disparity in user channel conditions exists, such as in urban environments with complex interference patterns or satellite networks with fluctuating line-of-sight conditions.

### Overview

Disclosed herein is a novel communication system enhancement for various wired and wireless networks that operates across modes including point-to-multipoint, multipoint-to-point, and multipoint-to-multipoint configurations. The disclosed technology may address the challenges faced by current communication systems by enabling multiple users or devices to share a single modulation symbol, and more particularly, by aggregating data streams from multiple users with differing channel conditions into a single shared modulation symbol. Further, by leveraging different modulation and coding schemes (MCS) based on user channel conditions, the disclosed technology can dynamically group data streams from users with disparate MCS levels, allowing them to transmit their information concurrently.

In one embodiment, the disclosed technology dynamically adapts modulation based on channel quality, using lower-order modulation (e.g., BPSK, QPSK) in poor conditions and higher-order modulation (e.g., 256 QAM) in optimal conditions. Modulation changes occur automatically to meet error rate targets, thereby balancing reliability and data throughput. In another embodiment, the disclosed technology allows data from multiple users to be combined into a single constellation point, maintaining the ability to carry distinct information for each user. This process involves selecting subsets of higher-order constellation points from standard modulations like 256 QAM, centering them around points associated with lower-order users for efficient transmission. In another embodiment, the disclosed technology applies schemes like MIMO, MU-MIMO, and Massive MIMO, along with advanced error correction to ensure accurate data reception, and offers flexibility in various access methods (e.g., TDMA, OFDMA). In another embodiment, the disclosed technology prioritizes pairing users with significant MCS differences, maximizing network throughput by allowing users with better channel conditions to operate alongside those with weaker conditions. In another embodiment, the disclosed technology can be integrated into current networks with minimal hardware changes, requiring only software updates to modulation/demodulation functions. The technique is adaptable to mobile, satellite, WiFi, and fixed wireless systems and is applicable to both new and legacy devices through selective configuration.

The disclosed technology provides various improvements and advantages over current technology, including improvements with respect to data transmission throughput, data transmission efficiency, data capacity, and/or energy efficiency. For instance:
The disclosed technology enables more efficient use of spectrum and power by allowing a shared modulation constellation to represent data for users with varying MCS levels. Users with poor channel conditions are assigned lower modulation schemes (e.g., QPSK), while those with better conditions use modified higher schemes (e.g., 256 QAM), but all data is transmitted using a subset of the highest modulation scheme's constellation points.
By transmitting data for multiple users within a single shared modulation symbol, the disclosed technology increases the amount of information conveyed per transmission cycle, improving overall throughput without the need for additional frequency or power resources.
By optimizing symbol usage across multiple users with different channel conditions, the disclosed technology may provide a substantial increase in data throughput and energy efficiency.
The shared modulation constellation disclosed herein allows networks to deliver more data in the same spectral footprint by simultaneously serving users with differing channel conditions. This design is particularly advantageous for high-density networks and spectrum-constrained environments.
By consolidating data transmission, the disclosed technology reduces the power per bit transmitted, which is beneficial for mobile and battery-operated devices. The shared modulation also enables power savings at the transmitter, as fewer independent transmissions are required for each user.
The disclosed technology can be implemented in both existing and new communication networks with minimal hardware changes, requiring only software or firmware updates at the modem or baseband level. This compatibility ensures that legacy devices can continue to operate transparently, while new devices can take full advantage of the enhanced capabilities.
The disclosed technology enables scalability across a wide range of network types and minimal implementation costs, potentially revolutionizing how data is managed in congested or bandwidth-limited environments.

In sum, the disclosed technology offers a powerful new approach to data transmission by leveraging a shared modulation constellation scheme, addressing the pressing need for more efficient, scalable, and power-conscious communication methods across diverse network types.

### BRIEF DESCRIPTION OF THE DRAWINGS

The various features of the present disclosure are illustrated in the drawings listed below and described in the detailed description that follows.

FIG. 1 illustrates the design of 2-users 8 QAM shared constellation with user 1 using standard QPSK and user 2 using standard 256 QAM under normal operations.

FIG. 2 illustrates the design of 2-users 16QAM shared constellation with user 1 using standard QPSK and user 2 using standard 256 QAM under normal operations.

FIG. 3 illustrates the design of 2-users 32QAM shared constellation with user 1 using standard QPSK and user 2 using standard 256 QAM under normal operations.

FIG. 4 illustrates the design of 2-users 64QAM shared constellation with user 1 using standard QPSK and user 2 using standard 256 QAM under normal operations.

FIG. 5 illustrates the design of 2-users 128QAM shared constellation with user 1 using standard 64QAM and user 2 using standard 256 QAM under normal operations.

FIG. 6 illustrates the design of 2-users 64QAM shared constellation with user 1 using standard 16 QAM and user 2 using standard 256 QAM under normal operations.

FIG. 7 illustrates the design of 2-users 32QAM shared constellation with user 1 using standard 16 QAM and user 2 using standard 64 QAM under normal operations.

FIG. 8 illustrates the design of 2-users 16QAM shared constellation with user 1 using standard QPSK and user 2 using standard 256 QAM under normal operations.

FIG. 9 illustrates the design of 2-users 16QAM shared constellation with user 1 using standard QPSK and user 2 using standard 64 QAM under normal operations.

FIG. 10 illustrates the design of 2-users 32QAM shared constellation with user 1 using standard QPSK and user 2 using standard 256 QAM under normal operations.

FIG. 11 illustrates the design of 2-users 16QAM shared constellation with user 1 using standard QPSK and user 2 using standard 256 QAM under normal operations.

FIG. 12 illustrates the design of 3-users 64QAM shared constellation with user 1 using standard QPSK, user 2 using standard 64 QAM and user 3 using standard 256 QAM under normal operations.

FIG. 13 illustrates the design of 2-users 8QAM shared constellation with user 1 using standard QPSK and user 2 using standard 16 QAM under normal operations.

### DETAILED DESCRIPTION

The technology disclosed herein is applicable to any wired or wireless communication network with the communication nodes that are configured to operate in a point-to-multipoint mode, multipoint-to-point mode or multipoint-to-multipoint mode where communication nodes including both the receivers and the transmitters can be located inside the building (indoor) or outside the building (outdoor), terrestrial or satellite, and can be stationary or mobile. Moreover, these modes can be operated using a single antenna or multiple antennas at the transmitter and receiver hence can be used with no-diversity, receiver diversity, transmit diversity, transmit and receiver diversity, MIMO, MU-MIMO, Massive MIMO, distributed MIMO, SFN (single frequency network), CoMP (Coordinated MultiPoint transmission), beamforming, etc. and can be used to transmit different kinds of information including user data, control data, voice data (e.g. VoLTE, VoNR, VoNG, etc.) or various different signals as defined in a given communication standard. In addition, these modes can operate in any multiple access techniques including TDMA, FDMA, OFDMA, TDD-OFDMA, FDD-OFDMA, SC-OFDMA, OTFS and their variations along with different scheduling including dynamic scheduling and semi-persistent scheduling.

A point-to-multipoint mode represents a scenario where a communication node of the communication network acts as a transmitter or a source node to transmit data to multiple receiver nodes of the communication network where each receiver node receives, at least in part, a distinct data intended for that particular receiver node only. Examples of the point-to-multipoint mode communication network include but not limited to 1) downlink of a cellular network where a transmitter such as a 3G/4G/5G/6G (3gpp standard based) macro base station, micro cell or small cell transmits data to different mobile handset users, fixed wireless customer premises equipment, IoT modules within the coverage area of the transmitter, 2) WiFi (IEEE 802.11 standards series) downlink where a WiFi access point transmits data to multiple mobile or fixed WiFi terminals, 3) Cable (DOCSIS based standard) downlink where CMTS (Cable Modem Transmission System) transmits data to multiple CM (cable modems) connected to the CMTS in the HFC (Hybrid Fiber Coax) network, 4) a satellite based communication network such as Starlink where an access point located in the satellite transmits information to multiple fixed or mobile terrestrial receivers and 5) IAB (Integrated Access Backhaul) where a node transmits to receivers including relay nodes as well as fixed or mobile users at the same time.

A multipoint-to-point mode represents a scenario where multiple communication nodes of the communication network act as a transmitter or a source node to transmit data to a single receiver node of the communication network where each transmitter node transmits, at least in part, a distinct data intended to be received by the same receiver node only. Examples of the multipoint-to-point mode communication network include but not limited to 1) uplink of a cellular network where multiple transmitters such as different mobile handset users, fixed wireless customer premises equipment, IoT modules transmit their individual and distinct data to a single receiver (that is closest to or within the coverage range) such as 3G/4G/5G/6G (3gpp standard based) macro base station, micro cell or small cell, 2) WiFi (IEEE 802.11 standards series) uplink where multiple mobile or fixed WiFi terminals transmit data that is received by a single WiFi access point (that is closest to or within the coverage range) 3) Cable (DOCSIS based standard) uplink multiple CMs transmit data to a single CMTS that those CMs are connected to via HFC network 4) a satellite based communication network such as Starlink where an access point located in the satellite receives information from multiple fixed or mobile terrestrial transmitters and 5) IAB (Integrated Access Backhaul) where a node receives distinct data from multiple receivers including relay nodes as well as fixed or mobile users at the same time in the uplink direction.

A multipoint-to-multipoint mode represents a scenario where multiple communication nodes of the communication network acts as a transmitter or a source node to transmit data to multiple receiver nodes of the communication network where each transmitter node transmits, at least in part, a distinct data intended to be received by the multiple receiver nodes. Examples given for the point-to-multipoint mode and multipoint-to-point mode can be expanded to include multipoint-to-multipoint mode for cellular network, WiFi terrestrial network, WiFi satellite based terrestrial network and IAB.

The communication network disclosed herein uses digital modulation schemes to transmit data between the source and the destination nodes. Examples of the digital modulation schemes include but not limited to BPSK, MPSK (such as 4 PSK, 8 PSK, 16 PSK, 32 PSK, 64 PSK, etc.), QAM (such as 4 QAM, 8 QAM, 16 QAM, 32 QAM, 64 QAM, 128 QAM, 256 QAM, 512 QAM, 1024 QAM, 2048 QAM, 4096 QAM, etc.). Use of a particular modulation scheme depends on the channel quality between the source and the transmitter. Typically, lower order modulations such as BPSK or 4 QAM are used in poor channel conditions where SNR or SINR is very low. Similarly for fair or good channel conditions, higher order modulations such as 16 QAM, 64 QAM are used whereas modulation schemes such as 128 QAM, 256 QAM or higher are typically used under excellent channel conditions with very high SNR or SINR. The nodes of the proposed communication network support multiple modulation schemes and adapt the modulation schemes based on the channel conditions at the time of the data transmission between the source and the destination nodes. For the selection of a particular modulation scheme along with the error correction code rate, a certain target error rate such as BLER (Block Error Rate), BER (Bit Error Rate or Symbol Error Rate) or Frame Error Rate is used. For example, if we assume that the target transmission error rate is 10% for the communication link between the transmitter and the receiver, then the communication system will ensure that the transmitter adopts a modulation scheme and associated error correction coding rate that achieves the transmission error rate that is close to 10%. If the transmission error rate is too high, then either modulation scheme can be lowered (i.e. use scheme that transmits less bits per symbol) or a stronger (i.e. lower rate error correction code) code be used or both lower modulation scheme along with stronger code can be used to bring the transmission error rate close to the target transmission error rate of 10%. Similarly, if the transmission error rate is too low, implying selection of an overly conservative modulation and error correction coding scheme, either the modulation scheme can be increased (i.e. use scheme that transmits more bits per symbol) or a weaker code (i.e. a higher rate error correction code) can be used or both higher modulation scheme along with weaker code can be used to bring the transmission error rate close to the target error rate of the transmission. In practical systems, only a certain predefined combinations of modulation scheme and error correction coding rate are used and are called MCS (Modulation and Coding Schemes). These MCSs are typically indexed starting with the lowest value, such as ‘0’ or ‘1’ corresponding to the lowest possible modulation scheme among the pool of modulation schemes allowed in the communication nodes (e.g. BPSK/QPSK) along with the strongest possible error correction code rate allowed in the communication node (e.g. ⅕, ⅙, etc.), to the highest MCS index where the highest possible modulation scheme among the pool of modulation schemes allowed in the communication node (e.g. 256 QAM/1024 QAM, etc.) along with the weakest possible error correction code rate allowed (or sometimes the data is transmitted uncoded) in the communication node (e.g. ⅚, 11/12, etc.) is used. The goal of the communication nodes for a particular link is to select the highest possible MCS for the transmission while satisfying the target transmission error rate requirement. In contemporary communication schemes, a particular symbol of a modulation scheme transmitted over the communication channel only carries information bits for a single user/device or layer. Please note that in case of MIMO, MU-MIMO, Massive MIMO, etc. the same channel resources are used for information transfer to multiple users or layers but each modulation symbol belonging to different layers of MIMO, MU-MIMO, Massive MIMO, etc. is pre-coded differently hence different symbols with different pre-coding are transmitted with different antennas, time or frequency/subcarrier and hence each individual modulation symbol with a specific pre-coding still transmits data bits for only a single user/device or layer. The disclosed technology allows the transmission and reception of data bits for multiple different users, devices or MIMO layers, beamforming layers in the network using a single shared modulation symbol.

The proposed scheme archives the transmission of the data bits for multiple users or devices via a single shared modulation symbol by grouping the suitable data streams of users or devices of the communication network together. The suitability of the different users/devices data streams for grouping is primarily determined by the difference in the MCS indexes (or channel quality) of the individual data streams of the users or devices that are grouped together. In a preferred embodiment, preference is given to group those individual user/device data streams that have the largest difference in their respective MCS index; however, the disclosed technology can work with any two or more data streams of users or devices associated with different MCS indexes. Those data streams for users or devices that have similar MCS index or same modulation scheme are not preferred for grouping together for the transmission via a single shared modulation symbol. MCS index associated with a data stream for a device or user here means the highest MCS index that ensures the achievement of the target transmission error rate within a certain margin.

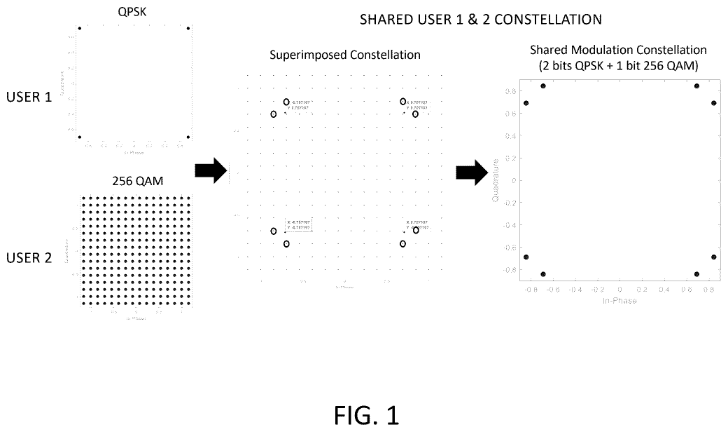

Let's discuss the disclosed technology with the help of an example where two user or device streams are paired and the data bits of the data streams are transmitted via a single shared modulation signal. For the sake of simplicity, we assume that both users are operating in single-input-single-output (SISO) mode although the disclosed technology can be generalized for various schemes including MIMO and MU-MIMO or massive MIMO as discussed earlier in the current disclosure. Assume that in the normal operation, user 1 operates with a MCS scheme with QPSK modulation and a coding rate R1 and user 2 operates with a MCS scheme with 256 QAM modulation and a certain rate R2. Depending upon the number of bits of user 2 to be transmitted over the single shared modulation symbol (the number of bits of user 2 has to be less than or equal to the 8 bits of 256 QAM symbol−2 bits of QPSK symbol), a subset of standard 256 QAM constellation points are selected for the transmission via a single shared modulation symbol. Assume that a single bit of user 2 is selected for the transmission along with 2 bits of user 1 then 23=8 constellation points that are part of the standard 256 QAM constellation form the single shared modulation constellation scheme for carrying data for both user 1 and user 2. In one embodiment, the 8 constellation points forming the single shared modulation constellation are picked from the standard 256 QAM constellation in such a way that they have the smallest Euclidean distance to the 4 standard constellation points of the standard QPSK or 4 QAM constellation or the constellation points of user 1 under normal operation as shown in FIG. 1. For example, the 8 constellation points of the single shared modulation constellation scheme can be picked such that they form 4 pairs of constellation points where each pair is located in a different quadrant closest to the standard QPSK or 4 QAM constellation point of that quadrant. In one embodiment, each of the four pairs of the 256 QAM constellation points can be picked in such a way that they each have the smallest Euclidean distance from the standard QPSK or 4 QAM point of the constellation (or the constellation of user 1 under normal operation) while having the maximum possible separation (in terms of Euclidean distance) between the two constellation points belonging to the same pair of the standard 256 QAM constellation points.

In another embodiment, the 8 constellation points forming the single shared modulation constellation are picked from the standard 256 QAM constellation in a different way such that they don't have the smallest Euclidean distance to the 4 standard constellation points of the standard QPSK or 4 QAM constellation or the constellation points of user 1 under normal operation. For example, the 8 constellation points of the single shared modulation constellation scheme can be picked such that they form 4 pairs of constellation points where each pair is located in a different quadrant but is not the closest to the standard QPSK or 4 QAM constellation point of that quadrant and average Euclidean distance of each pair of points to the nearest pair of point is different (greater or smaller) then the Euclidean distance between the closest points of a standard QPSK or 4 QAM constellation. In this embodiment, each of the four pairs of the 256 QAM constellation points can be picked in such a way that each pair of points do not have the smallest Euclidean distance from the standard QPSK or 4 QAM point of the constellation (or the constellation of user 1 under normal operation) while having the maximum possible separation (in terms of Euclidean distance) between the two constellation points belonging to the same pair of the standard 256 QAM constellation points.

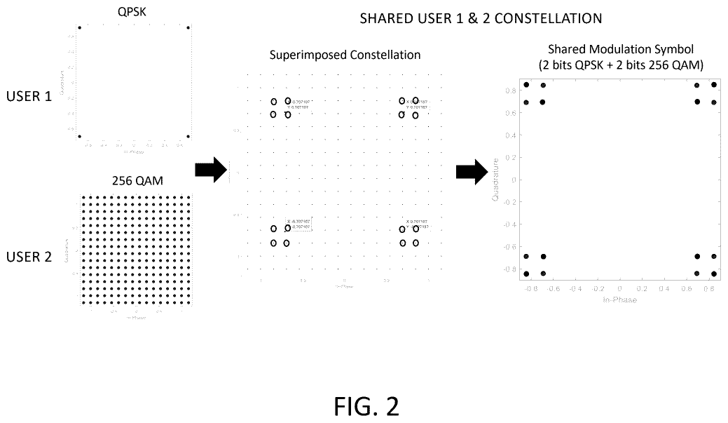

In the disclosed technology, user 1 can use the same code rate that is used by user 1 under normal operation or can use a stronger code to mitigate a potential degradation in the error rate performance (or weaker code in case of improved error performance due to higher power) while user 2 can use the same code rate that is used by user 2 under normal operation or a different code rate that can be higher or lower than the code rate used by user 2 under normal operation. In a preferred embodiment, a code rate for user 2 can be picked in such a way that that results in the same number of symbols transmitted in a frame as that of user 1 (or integral multiple of the number of symbols) for ease of operations while maintaining the targeted transmission error rate for user 2. In a scenario where two bits of user 2 are selected for the transmission along with 2 bits of user 1 then 24=16 constellation points that are part of the standard 256 QAM constellation form the single shared modulation constellation scheme for carrying data for both user 1 and user 2. In a preferred embodiment, the 16 constellation points forming the single shared modulation constellation are picked from the standard 256 QAM constellation in such a way that they have the smallest Euclidean distance to the 4 standard constellation points of the standard QPSK or 4 QAM constellation or the constellation points of user 1 under normal operation as shown in FIG. 2. For example, the 16 constellation points of the single shared modulation constellation scheme can be picked such that they form 4 sets of 4 constellation points where each set is located in a different quadrant closest to the standard QPSK or 4 QAM constellation point of that quadrant. In a preferred embodiment, each of the four sets of 4 constellation points of the 256 QAM constellation points can be picked in such a way that they each have the smallest Euclidean distance from the standard QPSK or 4 QAM point of the constellation (or the constellation of user 1 under normal operation) of each quadrant while having the maximum possible separation (in terms of Euclidean distance) between the four constellation points belonging to the same set of the constellation points of the standard 256 QAM constellation points. If the points in each set have unequal Euclidean distance to the standard QPSK or 4QAM constellation point of that quadrant, then 4 constellation points of the standard 256 QAM constellation with the smallest Euclidean distances (in the order of increasing Euclidean distance) from the standard QPSK or 4 QAM constellation point of that quadrant are selected.

In another embodiment, the 16 constellation points forming the single shared modulation constellation are picked from the standard 256 QAM constellation in such a way that they do not have the smallest Euclidean distance to the 4 standard constellation points of the standard QPSK or 4 QAM constellation or the constellation points of user 1 under normal operation. For example, the 16 constellation points of the single shared modulation constellation scheme can be picked such that they form 4 sets of 4 constellation points where each set is located in a different quadrant not closest to the standard QPSK or 4 QAM constellation point of that quadrant. In a preferred embodiment, each of the four sets of 4 constellation points of the 256 QAM constellation points can be picked in such a way that they each set have average Euclidean distance to the constellation points of the other set that is greater than the distance between the standard QPSK or 4 QAM points (or the constellation points of user 1 under normal operation). Moreover, the two bits belonging to user 2 can come from a single user with an MCS operating with the standard 256 QAM constellation under normal operation or can come from two (or multiple) separate users each operating with an MCS that employs the standard 256 QAM constellation under the normal operation. In the proposed scheme, user 1 can use the same code rate that is used by user 1 under normal operation or can use a stronger code to mitigate a potential degradation in the error rate performance (or weaker code if performance is improved due to increased power) while the user 2 (or multiple data streams for multiple users with same MCS as that of user 2) can use the same code rate that is used by user 2 (or multiple data streams for multiple users with same MCS as that of user 2) under normal operation or a different code rate that can be higher or lower than the code rate used by user 2 (or multiple data streams for multiple users with same MCS as that of user 2) under normal operation. In a preferred embodiment, a code rate for user 2 (or multiple data streams for multiple users with same MCS as that of user 2) can be picked in such a way that that results in the same number of symbols transmitted in a frame as that of user 1 (or integral multiple of the number of symbols) for ease of operations while maintaining the targeted transmission error rate for user 2.

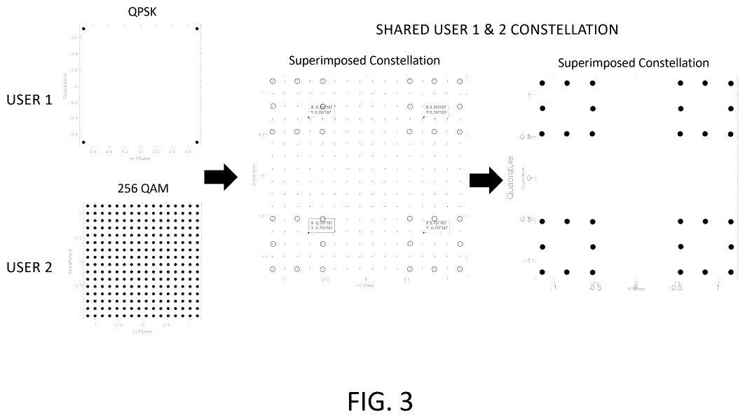

In another scenario where 3 bits of user 2 are selected for the transmission along with 2 bits of user 1 then 2⁵=32 constellation points that are part of the standard 256 QAM constellation form the single shared modulation constellation scheme for carrying data for both user 1 and user 2. In one embodiment, the 32 constellation points forming the single shared modulation constellation are picked from the standard 256 QAM constellation in such a way that they have the smallest minimum Euclidean distance to the 4 standard constellation points of the standard QPSK or 4 QAM constellation or the constellation points of user 1 under normal operation. For example, the 32 constellation points of the single shared modulation constellation scheme can be picked such that they form 4 sets of 8 constellation points where each set is located in a different quadrant closest to the standard QPSK or 4 QAM constellation point of that quadrant as shown in FIG. 3. In a preferred embodiment, each of the four sets of 8 constellation points of the standard 256 QAM constellation points can be picked in such a way that they each have the smallest Euclidean distance from the standard QPSK or 4 QAM point of the constellation (or the constellation of user 1 under normal operation) of each quadrant while having the maximum possible separation (in terms of Euclidean distance) between the 8 constellation points belonging to the same set of the 8 constellation points of the standard 256 QAM constellation. If the points in each set have unequal Euclidean distance to the stand QPSK 4 QAM constellation point of that quadrant, then the 8 constellation points of the standard 256 QAM constellation in each set with the smallest Euclidean distance (in the order of increasing Euclidean distance) from the standard QPSK 4 QAM constellation point of that quadrant are selected.

In another embodiment, the 32 constellation points forming the single shared modulation constellation are picked from the standard 256 QAM constellation in such a way that they don't have the smallest minimum Euclidean distance to the 4 standard constellation points of the standard QPSK or 4 QAM constellation or the constellation points of user 1 under normal operation. For example, the 32 constellation points of the single shared modulation constellation scheme can be picked such that they form 4 sets of 8 constellation points where each set is located in a different quadrant closest to the standard QPSK or 4 QAM constellation point of that quadrant. In this embodiment, each of the four sets of 8 constellation points of the standard 256 QAM constellation points can be picked in such a way that they each don't have the smallest Euclidean distance from the standard QPSK or 4 QAM point of the constellation (or the constellation of user 1 under normal operation) of each quadrant but instead each set of 8 points have average Euclidean distance greater than the Euclidean distance between standard QPSK/4 QAM constellation points from constellation points belonging to other set in a different quadrant. Moreover, the 3 bits belonging to user 2 can come from a single user with an MCS operating with the standard 256 QAM constellation under normal operation or can come from two or multiple different users each operating with an MCS that employs the standard 256 QAM constellation under the normal operation. In the proposed scheme, user 1 can use the same code rate that is used by user 1 under normal operation or can use a stronger code to mitigate a potential degradation in the error rate performance (or a weaker code because of performance enhancement due to increased power) while the user 2 (or multiple data streams for multiple users with same MCS as that of user 2) can use the same code rate that is used by user 2 (or multiple data streams for multiple users with same MCS as that of user 2) under normal operation or a different code rate that can be higher or lower than the code rate used by user 2 (or multiple data streams for multiple users with same MCS as that of user 2) under normal operation. In a preferred embodiment, a code rate for user 2 (or multiple data streams for multiple users with same MCS as that of user 2) can be picked in such a way that it results in the same number of symbols transmitted in a frame as that of user 1 (or integral multiple of the number of symbols) for ease of operations while maintaining the targeted transmission error rate for user 2 (or multiple data streams for multiple users with same MCS as that of user 2). Similarly, the process can be extended for scenarios where 4, 5, or 6 bits from user 2 (or multiple data streams for multiple users with the same MCS as that of user 2) are transmitted along with 2 bits from user 1 via a single shared modulation constellation scheme.

In general, a user with MCS 1 associated with a lower standard constellation consisting of 2^{x} constellation points transmitting x bits per symbol under normal operations can be combined with another user with MCS 2 associated with a higher standard constellation consisting of 2^{Y} constellation points transmitting Y bits per symbol (or multiple data streams for multiple users with the same MCS 2) under normal operation where Y>X for transmission via a single shared modulation symbol. For transmission of a total of Z bits (where Z<=Y−X) of user with MCS 2 (or multiple data streams for multiple users with the same MCS 2) along with X bits for the user with MCS 1, a subset of 2^{X+Z} constellation points from the set of constellation points of the standard 2^{Y} constellation are selected for forming the single shared modulation constellation to carry X bits for user with MCS 1 and Z bits for user with MCS 2 (or multiple data streams for multiple users with the same MCS 2). In a preferred embodiment, 2^{X+Z} constellation points from the set of constellation points of the standard 2 constellation are selected in such a manner that they form 2^{Y} different sets of constellation points with each set consisting of 2^{Z} distinct constellation points. In one embodiment, these sets of points can be centered around (or having smallest Euclidean distance to) each of the different constellation points of the standard 2^{X} constellation. In another embodiment, 2^{X+Z} constellation points from the set of constellation points of the standard 2^{Y} constellation are selected in such a manner that they form 2^{X} different set of constellation points with each set consisting of 2^{Z} distinct constellation points centered around (or having smallest Euclidean distance to) each of the different constellation points of the standard 2^{X} constellation while having the maximum possible separation in terms of Euclidean distance between the 2^{Z} constellation points within each group of 2^{X} distinct groups.

In a different embodiment, these sets of points are not centered around (or having smallest Euclidean distance to) each of the different constellation points of the standard 2^{X} constellation but are selected such that the average Euclidean distance between the constellation points belonging to one set of points to the constellation points belonging to another set of points is maximized. In another embodiment, 2^{X+Z} constellation points from the set of constellation points of the standard 2^{Y} constellation are selected in such a manner that they form 2^{X} different set of constellation points with each set consisting of 2^{Z} distinct constellation points not centered around (or having smallest Euclidean distance to) each of the different constellation points of the standard 2^{X} constellation while having the maximum possible separation in terms of Euclidean distance between the 2^{Z} constellation points of different groups or sets among 2^{x} distinct groups.

The single shared constellation uses the same precoding (if applicable) as used by the user with MCS 1 or lowest MCS among the users that are grouped. The overall bit labeling of the single shared constellation is a combination of bit labels for user 1 and user 2 (or multiple data streams for multiple users with the same MCS 2). For user 1 bit labeling, all the 2^{Z} constellation points that are part of the same group among the 2^{X} different groups of constellation points get the same bit labels (meaning labels repeated in each group) for X bits of user 1 that are assigned to the constellation point of the standard 2^{X} constellation that is closest (in terms of Euclidean distance) to those 2^{Z} constellation points. For user 2 bit labeling, a portion of the original bit labeling of the standard 2 constellation is used; that is each of the 2^{X+Z} constellation points of the single shared constellation point use only Z bits out of the Y bits label that are assigned to the standard 2^{Y} constellation point with the same I & Q value (Inphase & Quadrature). The Z bits out of Y bits label of the corresponding standard 2^{Y} constellation point label are selected in such a manner that each of the 2^{Z} constellation points Z bits labels within a same group among 2^{X} different groups get bits label that is unique within that group while maximizing the intra-bit distance for that bit position (Intra-bit distance for a particular bit position in a bits label is defined as the Euclidean distance between two constellation points where the bits label differs only in that bit position and all other bit positions of the bits label are identical. For example, assume point P1 has a bit label 11011 and point P2 has a bit label 11111, then the distance between P1 and P2 is called the intra-bit distance for bit position 3). The bit positions selected for choosing Z bits out of Y bits label remain fixed for all the 2^{X+Z} constellation points and can have consecutive bit positions or non-consecutive bit positions.

Therefore, for the transmission of X+Z bits of user 1 and user 2 (or multiple data streams for multiple users with the same MCS 2) via single shared 2^{X+Z} constellation where the constellation points are a subset of the constellation points of a standard 2^{Y} constellation, in the first step, based on the bit values of X bits of user 1 data stream, one of the 2^{X} groups of constellation points in the single shared 2^{X+Z} constellation is selected where the constellation points are closest or closer but not closest (in terms of Euclidean distance) to the constellation point of the standard 2^{X} constellation with the bit label corresponding to X bits of user 1 data stream, then secondly, based on the bits values of Z bits of user 2 data stream (or multiple data streams for multiple users with the same MCS 2), one of the 2^{Z} constellation points within the chosen group among the 2^{X} group selected in the first step is picked where the bit label matches with the Z bits values of the user 2 data stream. Hence steps 1 and 2 result in transmission of a single constellation point of the single shared 2^{X+Z} constellation where the selection of the transmitted signal constellation point is based on the X bit values of user 1 data stream and Z bit values of user 2 data stream (or multiple data streams for multiple users with the same MCS 2).

In one embodiment, the subset of the standard 2^{Y} constellation points that form the single shared modulation scheme described above in selected in such a way that the average power of all the constellation points in the single shared 2^{X+Z} constellation is same as OR less than the standard 2^{X} constellation or the standard 2^{Y} constellation. This also enables transmission power/energy savings at the transmitter(s) of the proposed communication system as the transmitter keeps the same average power for transmission as that in a normal operation while transferring data of multiple users or data streams. Hence the proposed scheme archives less power per bit sent compared to normal operation.

In a different embodiment, the subset of the standard 2 constellation points that form the single shared modulation scheme described above in selected in such a way that the average power of all the constellation points in the single shared 2^{X+Z} constellation is same as OR more than the standard 2^{X} constellation or the standard 2 constellation.

On the receiver side, user 1 treats the received signal as a regular constellation point of the standard 2^{X} constellation and calculates the LLR (log likelihood ratio) of X bits to be later used for decoding user 1 data stream in the standard manner. For user 2 (or multiple data streams for multiple users with the same MCS 2), the received signal is treated as a constellation point of a 2^{X+Z} single shared modulation constellation scheme or a standard 2^{Y} standard constellation. Since the 2^{X+Z} single shared modulation constellation scheme is a subset of a 2 standard constellation that is used by the communication nodes in the normal operation based on the channel condition, user 2 (or multiple data streams for multiple users with the same MCS 2) is already capable of detecting the received signal point as a standard 2^{Y} constellation point. Hence user 2 (or multiple data streams for multiple users with the same MCS 2) can simply use the same approach to calculate LLRs for all Y bits for the received signal as incase of standard 2^{Y} constellation point transmission and simply discard the LLRs for those (Y-Z) bit positions that are not assigned or used in the 2^{X+Z} single shared modulation constellation scheme although part of standard 2^{Y} constellation and only use those Z bit positions for LLR values that are used to carry data for user 2 (or multiple data streams for multiple users with the same MCS 2) and pass the Z bits LLRs for each received symbol to the decoder. Optionally user 2 (or multiple data streams for multiple users with the same MCS 2) can modify the LLR calculation and only calculate the LLRs for Z bits by appropriately modifying the LLR calculation mechanism used in the standard 2^{Y} constellation detection. Essentially in the second approach, LLRs calculation mechanism uses the same approach as the approach used in the calculation of LLRs for the Y distinct bits in each symbol as in case of the standard 2^{Y} constellation detection, but instead of using this approach for all Y bit positions, the approach is used for only Z bit positions that are actually used to carry information for user 2.

Another approach is to modify existing standard demodulators that expect to receive any one of the constellation points of the standard constellations with equal likelihood in such a way the modified demodulators do not expect transmission of all constellation points of the standard constellation with equal likelihood but only expect to receive a subset of constellation points that are part the shared constellation scheme with equal likelihood and likelihood of remaining constellation points of the standard constellation that are not part of shared constellation scheme as zero.

Let us consider a generalized two user shared constellation scheme. Consider a user 2 constellation A(s) with constellation points aᵢ, i=1,2 . . . , N, and a user 1 constellation B(s) with constellation points bⱼ, j=1,2 . . . , M. The constellations A(s) and B(s) can be standard constellations or a selected set of constellation points of a standard constellation. In the shared constellation schemes disclosed herein, a scaled (or shifted) and possibly rotated constellation A(s) is placed at or near each constellation point of B(s). Hence, the resulting shared user constellation can be generally expressed as:

$$C ( s ) = sum\_i = 1 \hat{} N j = 1 \hat{} M cjA ( s - bj )$$

where, cj is the scaling factor (or shifting factor) used when placing a copy of A(s) at the constellation point s=bⱼ. In general, cj=alpha_j e\hat{ }jtheta, where alpha_j and theta_j are respectively the magnitude and the phase of the scaling factor cj.

With the above view of a shared user constellation scheme, the channel information (log likelihood values) of the user 2 bits can be extracted using the approach described here. First note that each constellation point of C(s) is associated with one specific user 1 constellation point bⱼ and one specific user constellation point aᵢ. As a result, for that specific user 1 constellation point bⱼ, the following operation:

$$[ C ( s ) - bj ] / cj = [ C ( s ) - bj ] / alpha\_j * exp ( - theta\_j )$$

results in the constellation point aᵢ of the user 2 constellation A(s). Therefore, if C(s) is replaced by the received signal r in the above equation as:

$$[ r - bj ] / cj = [ C ( s ) - bj ] / alpha\_j * exp ( - theta\_j )$$

We can extract the channel information of the user 2 metrics on the user 2 signal constellation A(s) for the correctly chosen transmitted user 2 set of constellation points identified by bj. Note also that the user 1 constellation points are separated by a distance much greater than the distance between constellation points of the user 2 constellation A(s). Therefore, except for the transmitted user 1 constellation point (and associated user 2 set of constellation points) bj, the channel information obtained using the last equation for any other bk, k≠j, would be very small and negligible.

The channel information of the user 1 bits can be easily extracted using the received signal r on the standard user 1 constellation B(s) as in regular demodulation.

Notice that each constellation point ai of the user 2 constellation A(s) corresponds to a combination of log_2N user 2 bits, c1,c2, . . . , c_log_2N. Therefore, the channel information of each user 2 bit c_el, denoted here by L(c_el), el=1,2, . . . , log_2N, can be extracted in the proposed shared constellation scheme by using any of the following two methods.

Method 1: For every user 1 constellation point bj, j=1,2 . . . , M, transform the received signal to form

$${r}^{′} ( j ) = [ r - bj ] / cj = [ C ( s ) - bj ] / alpha\_j * exp ( - theta\_j )$$

and use that r′(j) on the constellation A(s) to calculate a channel information value L(c_el,bⱼ) of each user 2 bit c_el corresponding to that jth user 2 constellation point. Then the channel information of every elth user 2 bit is obtained by

$$L ( c\_el ) = Max\_j \{ L ( c\_el , bj ) \} , j = 1 , 2 , … , M , el = 1 , 2 , … , log\_ 2 N$$

Method 2: Note that in method 1, the maximization according to equation in Method 1 allows selecting different user 1 constellation points to calculate channel information of different user 2 bits. However, for every transmitted shared constellation symbol, there exists a corresponding unique user 2 constellation point. Therefore, method 2 focusses on first estimating that most probable user 1 constellation point and using that user 1 constellation point to calculate the channel information of every user 2 bit. The most likely user 2 constellation point bj\hat{ } can be found by performing the following maximization

$$bj \hat{}= Max\_j Sum\_el \{ L ( c\_el , bj ) \}$$

Once, bj\hat{ } is identified, the channel information of each user 2 bit is found according to

$$L ( c\_el ) = L ( c\_el , b\_j \hat{} ) , el = 1 , 2 , … , log\_ 2 N$$

It is mentioned here that both methods 1 and 2 have the same complexity as they both require the same amount of calculations. Further, as SNR increases both methods 1 and 2 are expected to perform in the same manner.

Let's discuss the disclosed technology with the help of an example where three users or devices streams, with three different assigned MCSs associated with 3 distinct modulation schemes under normal operation, are grouped together and data bits of their data streams are transmitted via a single shared modulation signal. For the sake of simplicity, we assume that all three users (or data streams) operate in single-input-single-output (SISO) mode although the concept can be generalized for various schemes including beamforming, MIMO and MU-MIMO or massive MIMO as discussed earlier in the current disclosure. Assume that in the normal operation, user 1 operates with a MCS scheme with QPSK modulation and a coding rate R1, user 2 operates with a MCS scheme with 64 QAM modulation and a certain rate R2, and user 3 operates with a MCS scheme with 256 QAM modulation and a certain rate R3. The process of forming the single shared constellation starts by determining that number of bits transferred by each user with the single shared constellation point. Assume that in the single shared constellation, the number of bits transferred by user 1 is 2 bits, the number of bits transferred by user 2 is 2 bits and the number of bits transferred by user 3 is also 2 bits. Please note that number of bits used in this example for each user are selected just for the sake of simplicity in explanation and in general user 1, user 2 and user 3 can transmit any number of bits in the single shared constellation as long as the sum of their individual number of bits per the single shared symbol does not exceed the number of bits per symbol transmitted in the normal operation by the highest MCS user For example, the sum of total bits transmitted by all 3 users does not exceed 8 that is the maximum number of bits that the user with the highest constellation under normal operation i.e. user 3 with 256 QAM constellation can carry. In general, the maximum number of total bits transmitted by the single shared constellation for all users is always less than or equal to the number of bits the user with the highest constellation under normal operation can carry. In this 3 user example, since a total of 6 bits are transmitted over the single shared modulation symbol, hence a subset of 2⁶=64 points out of the total of 2⁸=256 points of the standard 256 QAM constellation points are selected for the formation of the single shared modulation constellation to carry data for all 3 users. The 64 constellation points of the shared constellation are selected in multiple steps. In the first step of the preferred embodiment, user 1, user 2 and their associated constellations under normal operation i.e. 4 QAM and 64 QAM are considered for an initial set or preliminary set of 16 constellation points. Specifically for each constellation point of the standard 4 QAM constellation associated with user 1 in normal operation in each quadrant, 4 such constellation points of the standard 64 QAM constellation associated with user 2 in normal operation are selected in each quadrant that are the closest (in terms of Euclidean distance) to the constellation point of the standard 4 QAM constellation in that quadrant. In the preferred embodiment, each set of 4 constellation points of the standard 64 QAM constellation are selected in a such a way that they have the maximum possible separation (in terms of Euclidean distance) between the four constellation points belonging to the same set while satisfying the previous condition of being the closest (in terms of Euclidean distance) to the constellation point of the standard 4 QAM constellation. If the points in each set have unequal Euclidean distance to the standard QPSK or 4 QAM constellation point of that quadrant, then 4 constellation points of the standard 64 QAM constellation with the smallest Euclidean distances (in the order of increasing Euclidean distance) from the standard QPSK or 4 QAM constellation point of that quadrant are selected. This step results in creation of the initial or preliminary set of 16 constellation points (4 in each quadrant) that are part of the standard 64 QAM constellation and are closest to (in terms of Euclidean distance) or centered around each of the four standard 4 QAM constellation points. In the next step, user 2, user 3 and their associated constellations under normal operation i.e. 64 QAM and 256 QAM are considered for the final set of 64 constellation points that are a subset of constellation points of the standard 256 QAM constellation. In this second step, in the preferred embodiment, for each of the initial or preliminary 16 constellation points of the standard 64 QAM constellation selected in the previous step, 4 such constellation points of the standard 256 QAM constellation associated with user 3 under normal operation are selected that are the closest (in terms of Euclidean distance) to the respective initial or preliminary constellation point selected in previous step. In the preferred embodiment, each set of 4 constellation points of the standard 256 QAM constellation are selected in a such a way that they have the maximum possible separation (in terms of Euclidean distance) between the four constellation points belonging to the same set while satisfying the previous condition of being the closest (in terms of Euclidean distance) to the constellation point of the standard 64 QAM constellation. If the points in each set have unequal Euclidean distance to the standard 64 QAM constellation point, then 4 constellation points of the standard 256 QAM constellation with the smallest Euclidean distances (in the order of increasing Euclidean distance) from their respective standard 64 QAM constellation point are selected. This step results in the creation of final single shared constellation consisting of 64 points that are a subset of constellation points of the standard 256 QAM constellation and are the closest to (in terms of the Euclidean distance) or centered around each of the 16 initial or preliminary set of the standard 64 QAM constellation points. Similar to the 2 user example discussed previously, user 1 can use the same code rate that is used by user 1 under normal operation or can use a stronger code to mitigate a potential degradation in the error rate performance, user 2 can use the same code rate that is used by user 2 under normal operation or can use a stronger code to mitigate a potential degradation in the error rate performance and similarly user 3 can use the same code rate that is used by user 3 in normal operation or a different code rate that can be higher or lower than the code rate used by user 3 under normal operation. In a preferred embodiment, a code rate for user 2 and user 3 is picked in such a way that that results in the same number of symbols transmitted in a frame as that of user 1 (or integral multiple of the number of symbols) for ease of operations while maintaining the targeted transmission error rate for user 2 and user 3. Moreover, the two bits belonging to user 2/3 can come from a single user with an MCS operating with the standard 64 QAM/256 QAM constellation under normal operation or can come from two (or multiple) separate users each operating with an MCS that employs the standard 64 QAM/256 QAM constellation under the normal operation.

The process of formation of a single shared constellation for E (E>=2) users, where each associated with a different standard constellation C_{E} in normal operation associated with code rate R_{E}, is as a follows:
1. The users are arranged in an increasing order (1,2 . . . , E) of their constellation size (e.g. BPSK, QPSK, 16 QAM, 64 QAM, 256 QAM, . . . ,) used in their normal operation.
2. The number of bits for each user B_{E} to be carried by the single shared constellation symbol is determined along with the associated code rate R_{E}. The number of bits Bᵢ for the i^{th} user can only be less than or equal to the number of bits transmitted by user i in normal operation and sum of bits of all users i.e. B₁+B₂+ . . . +B_{E} can only be equal to or less than the total number of bits transmitted by user E's symbol (or the standard constellation C_{E}) in normal operation. The code rates, in a preferred embodiment, can be equal to or lower (stronger) than that user's code rate in normal operations except the highest level E where the code rate can be equal to, higher or lower than the code rate used in the normal operation. In a preferred embodiment, code rates are selected in such a manner that based on the Bᵢ number of bits transmitted during each symbol for i^{th} user, the result is the same number (or integral multiple of) of constellation symbols for each user per frame or packet while satisfying the previous condition. Bits Bᵢ for i^{th} user here can come from a single physical user or multiple physical users as long as all those multiple physical users have similar channel conditions and use the same modulation symbol and code rate under normal operation.
3. The process starts with two users with the lowest order i.e. user 1 and the second lowest order i.e. user 2:
   i. A subset of 2^{B1} constellation points of the standard constellation C₁ used by the lowest order user 1 are selected such that the 2^{B1} constellation points have maximum possible separation (in terms of the Euclidean distance) from each other. For each of the selected 2^{B1} constellation points, 2^{B2} number of constellation points of the standard C₂ are selected in such manner that each set of the 2^{B2} constellation points of the standard C₂ are closest (in terms of the Euclidean distance) to their respective one of the 2^{B1} constellation point of the standard C₁ constellation. If the set of 2^{B2} points have unequal Euclidean distance to their respective one of the 2^{B1} constellation point of the standard C₁ constellation, then 2^{B2} points of the standard C₂ constellation are selected such that they have the smallest Euclidean distance (in the order of increasing Euclidean distance) from their respective standard constellation point of C₁ constellation. In the preferred embodiment, it is attempted to find each of those set of 2^{B2} near their corresponding standard C₁ constellation point such that each point within a set of 2^{B2} of constellation points have maximum separation (in terms of the Euclidean distance) with other constellation points belonging to the same set while satisfying the previous conditions. This set results in a preliminary set of 2^{B1}x2^{B2} constellation points belonging to the C₂ constellation.
   ii. The step 3.1 is repeated while dropping the lowest order user and moving to the next two lowest orders users (e.g. in the 1st iteration, user 2 becomes the lowest order user and user 3 becomes the second lowest order user, in the 2nd iteration, user 3 becomes the lowest order user and user 4 becomes the second lowest order user, and so on) in each iteration, with the preliminary 2^{B1}x2^{B2}x . . . x2^{B(i-1)} constellation points belonging to the standard Cᵢ₋₁ selected in the previous iteration become the selected points for lowest order user for the current iteration, until the last user with the highest constellation among the group of users i.e. user E with C_{E} standard constellation is reached and the process is stopped; in other words, the iteration where the lowest order user is user (E-1) and second lowest user is E becomes the last iteration of this process. The final constellation consists of a subset of 2^{B1}x 2^{B2}x . . . x2^{B(E-1)} x2^{BE} constellation points belonging to the standard C_{E} selected such that these are centered around a subset of preliminary selected 2^{B1}x2^{B2}x . . . x2^{B(E-1)} constellation points belonging to the standard CE-1 constellation selected in the previous iteration.

The overall bit labeling of the single shared constellation is a combination of bit labels for all the users from user 1 to user E as explained below:
For the lowest order user i.e. user 1 using the standard C1 constellation during normal operation, the single shared constellation can be viewed as 2^{B1} sets of 2^{B2}x . . . x2^{BE} constellation points of the standard C_{E} constellation centered around 2^{B1} constellation points of the standard C₁ constellation.
   1. If B₁ equals to the number of bits transmitted by the standard C₁ constellation per symbol, then all the 2^{B2}x . . . x2^{BE} constellation points in each of the 2^{B1} sets assume the same bits label as the bits label used by the constellation point of the standard C₁ constellation these 2^{B2} . . . x2^{BE} constellation points of C_{E} constellation are centered around.
   2. If B₁ is less than the number of bits transmitted by the standard C₁ constellation per symbol, then all the 2^{B2}x . . . x2^{BE} constellation points in each of the 2^{B1} sets assume a portion of bits label consisting of B₁ bits used by the constellation point of the standard C₁ constellation these 2^{B2}x . . . x2^{BE} constellation points of C_{E} constellation are centered around; the portion of the bits label is selected in such a way that each of the 2^{B1} sets gets a unique bits label assigned such that user 1 bits labels for all 2^{B2}x . . . x2^{BE} constellation points are same within the set but are different from constellation points belonging to a different set while maximizing the intra-bit distance for the bits labels between different sets.
Similarly, for second order user i.e. user 2 using the standard C₂ constellation during normal operation, the single shared constellation can be viewed as 2^{B1}x2^{B2} sets of 2^{B3}x . . . x2^{BE} constellation points of the standard C_{E} constellation centered around 2^{B1}x2^{B2} constellation points of the standard C₂ constellation.
   1. If B₂ equals to the number of bits transmitted by the standard C₂ constellation per symbol, then all the 2^{B3}x . . . x2^{BE} constellation points in each of the 2^{B1}x2^{B2} sets assume the same bits label as the bits label used by the constellation point of the standard C₂ constellation these 2^{B3}x . . . x2^{BE} constellation points of C_{E} constellation are centered around.
   2. If B₂ is less than the number of bits transmitted by the standard C₂ constellation per symbol, then all the 2^{B3}x . . . x2^{BE} constellation points in each of the 2^{B1}x2^{B2} sets assume a portion of bits label consisting of B₂ bits used by the constellation point of the standard C₂ constellation these 2^{B3}x . . . x2^{BE} constellation points of C_{E} constellation are centered around; the portion of the bits label is selected in such a way that each of the 2^{B1}x2^{B2} sets gets a unique bits label assigned such that user 2 bits labels for all 2^{B3}x . . . x2^{BE} constellation points are same within the set but are different from constellation points belonging to a different set while maximizing the intra-bit distance for the bits labels between different sets.
Similarly, for it order user i.e. user i using the standard Cᵢ constellation during normal operation, the single shared constellation can be viewed as (2^{B1}x2^{B2} . . . x2^{Bi}) sets of 2^{B(i+1)}x . . . x2^{BE} constellation points of the standard C_{E} constellation centered around (2^{B1}x2^{B2} . . . x2^{Bi}) constellation points of the standard Cᵢ constellation.
   1. If Bᵢ equals to the number of bits transmitted by the standard Cᵢ constellation per symbol, then all the 2ⁱ⁺¹x . . . x2^{BE} constellation points in each of the (2^{B1}x2^{B2} . . . x2¹) sets assume the same bits label as the bits label used by the constellation point of the standard Cᵢ constellation these 2ⁱ⁺¹x . . . x2^{BE} constellation points of C_{E} constellation are centered around.
   2. If Bᵢ is less than the number of bits transmitted by the standard Cᵢ constellation per symbol, then all the 2ⁱ⁺¹x . . . x2^{BE} constellation points in each of the (2^{B1}x2^{B2} . . . x2ⁱ) sets assume a portion consisting of Bᵢ bits of bits label used by the constellation point of the standard Cᵢ constellation these 2ⁱ⁺¹x . . . x2^{BE} constellation points of C_{E} constellation are centered around; the portion of the bits label consisting of Bᵢ bits is selected in such a way that each of the (2^{B1}x2^{B2} . . . x2Bᵢ) sets gets a unique bits label assigned such that user i bits labels for all 2ⁱ⁺¹x . . . x2^{BE} constellation points are same within the set but are different from constellation points belonging to a different set while maximizing the intra-bit distance for the bits labels between different sets.
Finally, the highest order user i.e. user E using the standard C_{E} constellation during normal operation, the single shared constellation can be viewed as 2^{B1}x2^{B2} . . . x2ⁱx2ⁱ⁺¹x . . . x2^{B(E-1)} sets of constellation points of the standard C_{E} constellation. From user E's perspective, these constellation points in each set are not centered around a lower order constellation but are actually mapped on the exact locations of a subset of the standard C_{E} constellation points. In a scenario where B_{E} is less than the number of bits transmitted by the standard C_{E} constellation per symbol, then all the 2^{BE} constellation points within each set assume a unique bits label from a group of distinct 2^{BE} bits labels but this same group of distinct 2^{BE} bits labels are used in each of the 2^{B1}x2^{B2} . . . x2ⁱx2ⁱ⁺¹x . . . x2^{B(E-1)} sets; the portion of the bits label consisting of B_{E} bits is selected in such a way that each of the 2^{BE} bits gets a unique bits label assigned within the set such that user E bits labels for all 2^{B(i+1)}x . . . x2^{BE} constellation points are different within the set but are same as the constellation points belonging to a different set while maximizing the intra-bit distance for the bits labels between the constellation points within a same set.

Once bit labeling for the overall single shared constellation is completed which consists of bits labels along with their respective position for each user level/modulation order from user 1 till user E, then for the data to constellation point mapping for the single shared constellation, B₁ bits from user 1 stream, B₂ bits from user 2 stream, . . . Bᵢ bits from user i stream, . . . , and B_{E} bits from user E data stream are used to form the overall bits label for the single shared constellation and corresponding signal point of the single share constellation is transmitted to carry data bits of all the grouped users.

Generalized receive operation: Following are the steps involved in the generalized receive operation of disclosed technology where a single shared modulation constellation symbol carrying data of multiple users is detected and decoded by multiple users to decode their respective data.
User 1: On the receiver side, user 1 treats the received signal as a standard constellation point (or a subset of constellation points) of the standard C1 constellation and calculates the LLR (log likelihood ratio) of B1 bits for each receive symbol to be later used for decoding user 1 data stream in the standard manner.
User 2: For user 2, the received signal is treated as
   either from a subset of the standard C2 constellation consisting of 2B1x2B2 points. In this case, the demodulator calculates the LLRs of only B2 bits out of the total number of bits that a standard C2 constellation carries during the normal operation. The bit positions of those B2 bits correspond to the B2 bits portion (for user 2) of the overall bits label designed for the single shared constellation. Or
   from a regular standard C2 constellation signal in transparent mode. In this case, the demodulator calculates the LLRs for all the bit positions of the standard C2 symbol just as in normal operations, but forwards LLRs to the decoder for the bit positions of only those B2 bits that correspond to the B2 bits portion (for user 2) of the overall bits label designed for the single shared constellation.
User i: For user i, the received signal is treated as
   either from a subset of the standard Ci constellation consisting of 2B1x2B2x2Bᵢ points. In this case, the demodulator calculates the LLRs of only Bi bits out of the total number of bits that a standard Ci constellation carries during the normal operation. The bit positions of those Bi bits correspond to the Bi bits portion (for user i) of the overall bits label designed for the single shared constellation. Or
   from a regular standard Ci constellation signal in transparent mode. In this case, the demodulator calculates the LLRs for all the bit positions of the standard Ci symbol just as in normal operations, but forwards LLRs to the decoder for the bit positions of only those Bi bits that correspond to the Bi bits portion (for user i) of the overall bits label designed for the single shared constellation.

It is to be noted that the single shared constellation uses the same precoding (if applicable) as used by the user with MCS 1 or lowest MCS user among the group of users that are selected for data transmission via the single shared constellation.

The process of implementing this disclosed technology in existing communication systems through a software update may involve making changes in the existing code at the transmitter and the receiver. In general, the disclosed technology improves that data link capacity in the downlink and in the uplink by modifying the bits to the modulation symbol mapping process at the transmitter and the demodulation process at the receiver. In other words, the technique can be software implemented by making changes in the digital modulation and the digital demodulation section of the code used for the logical data channels that carry the user information in downlink and uplink. Although the disclosed technology can be implemented for any kind of channel but in a scenario where the technology is mainly implemented for data channels, certain changes need to be made that are not directly linked to the disclosed technology. For example, based on the implementation of the code, the functions or routines for carrying out the tasks for digital modulation and digital demodulation for data channels in the code may also be used for other channels including but not limited to signaling channels, control channels, synchronization channels, paging channels, reference signal channels, pilot channels etc. In this case, code segregation is needed for modulation and demodulation between data channels and all the other channels. Moreover, even for data channels, the disclosed technology may only be used when a lower modulation order user is paired or grouped with higher modulation order user or users and the communication system may not use the proposed innovation technique during the normal operation. Hence, it may be required to write code with different versions of functions or routines to carry out modulation and demodulation 1) while the disclosed technology of a shared single constellation is used for data channels and 2) while the proposed technique is not used for data channels or for channels other than the data channels.

Secondly, in terms of protocol stack implementation, operations above the modulation-mapping step such as bit scrambling, coding, etc. remain same (for the most part) for all the users whether they are modulating/demodulating under normal operations or participating in the single shared constellation. However, for the steps following the modulation mapper stage, code changes are required as these steps are not performed individually for each user data stream but are performed only once collectively for all the grouped users and the process is these lowers stages after modulation-mapping (in downlink; in the uplink the order is reversed) is governed by the lowest modulation order user. As an example, the following changes can be done to LTE standard code for two users where a low MCS user is called COTSUE (QPSK user) and higher MCS user is called SRSUE and the transmitter is called SRSENB. Set a flag when SRSUE is attached. It also has a counter along with a flag to keep a track on the number of transmissions. The need of the counter is to switch the QPSK modulation code with modified codes after a pre-defined number of transmissions. This can be added to make sure that the algorithm changes are always working irrespective of modified QPSK codes. Modify find_optimal_rbgmask( ) function to allocate all possible RBG's to every UE, irrespective of requested bytes. The modification involves commenting out the code which reduces the grant based on request. The changes are specific to DRB (Data Radio Bearer). The encode procedure is divided into following logical blocks:
1. Find UE index from the grants list (allocated by MAC) against UE type.
2. Perform these operations for each UE:
   i. DCI to Grants.
   ii. Set softbuffers
   iii. Channel coding.
   iv. Bit Scrambling.
   v. Store the bitstream of each UE in a temporary data structure for later use.
3. Perform modulation based on the number of connected UE.
   If the number of connected UEs is one then determine whether the connected UE is a COTSUE or SRSUE. In one setup example, rnti's 0x46 & 0x47 are reserved for COTSUE and rnti's greater than are reserved for SRSUE. It is required to choose specific codes (bits to complex symbol mapping) symbols from the modified modulation table and are loaded against the QPSK channel.
   If connected UEs are two then COTSUE bitstream together with SRSUE bitstream help to select the codes (bits to complex symbol mapping) from the modified modulation table and are loaded against the QPSK channel.
4. Perform these operations for each UE (In two UE cases, only do it for COTUE).
   Layer mapping.
   Precoding.
   Mapping to resource elements.

In SRSUE, the changes are mostly in the PDSCH decoder. The decoder for QPSK modulation is either replaced by 64 QAM decoder or 256 QAM decoder or 16 QAM decoder. This depends on the type of code loaded at the PDSCH encoder in enodeB. The objective is to find the LLR specific to SRSUE from the transmitted codes. In one implementation, only PRB mask information of SRSUE in DCI (downlink control information) is modified and PRB mask contents from COTSUE's DCI is copied and the rest of the information of DCI for SRSUE remains unchanged. In some implementations, SI-RNTI (for system broadcast information) may also need to be adjusted for a shared constellation scheme.

In the disclosed technology, multiple users data is transmitted via the same signal so that results in energy or power savings and as no separate transmission is required for each of the multiple users that participate in data transmission via single share constellation. Moreover, in some embodiments of the disclosed technology, the same or less average energy or power per symbol is used that results in additional energy saving.

User Pairing: In the following, user pairing mechanism of the disclosed technology is described in detail:
One principle of the disclosed technology is that any two or more users (user 1, user 2, . . . user E) can be paired or grouped together for at least a subset (including the super set) of those channel resources that are allocated to the lowest order user if the total effective throughput of the single shared constellation carrying data of all grouped users from user 1 to user E i.e. ER₁+ER₂+ . . . ER_{E} is greater than the effective throughput of the lowest order user i.e. user 1 in ER′₁ in normal operation as this will result in overall increase of capacity of the communication network.
It is preferred to consider those users for pairing or grouping that have data ready for transmission. In one embodiment, pairing or grouping can be limited to only those users that are scheduled for transmission by scheduler for the current transmission time interval (TTI). Pairing or grouping can be dynamic, for example in case of cellular networks or WiFi networks or can be static/semi static in certain cases of cable networks.
It is preferred to pair or group users with larger differences in channel conditions. For example, assume in normal operation user 1 uses 4 QAM constellation, user 2 uses 16 QAM constellation, user 3 uses 64 QAM constellation and user 4 uses 256 QAM constellation and if grouping is limited to only pairs of users than it is preferred to pair user 1 with user 3 and user 2 with user 4 to ensure the largest possible channel condition difference among the users that are grouped together.
It may be possible (especially in cellular mobile networks) to change the narrow beam precoding, that is used in the normal operations, of a lower order user to a wider beam precoding to enable the lower order user to be paired or grouped with other higher order users that were not originally in the coverage area of the narrow beam used for the lower order user as long as the operation results in overall improvement of the effective rate for the resources that transmit single shared constellation compared to the effective rate of the lower order user for those resources.
Although the main criteria is to pair or group users using a single shared constellation to improve the effective throughput of the communication channel resources assigned to the lower order user; other criteria include latency requirement, priority requirement, error rate requirement, etc., that can also be used to modify the user pairing or grouping to result in effective throughput that is less than the maximum possible effective throughput but better in some other criteria.

The disclosed technology can also be viewed as multi level codes with codes at different levels (i.e. different minimum Euclidean distances) belonging to different users with different channel conditions. This is different from traditional MLC (multilevel coding) where all the codes at different levels are used for the same user. In this case of MU-MLC using sparse constellation, the user with weakest channel condition (e.g. cell edge user) is assigned the level with largest minimum Euclidean distance between set of constellation points of the sparse constellation and the user with better channel conditions (e.g. cell center user) is assigned a coding level with Euclidean distance smaller than the Euclidean distance of the coding level assigned to the user with weakest channel condition. Typically, the better the channel condition of the user is, the smaller the Euclidean distance of the coding level assigned to the user. Similarly, the user with the best signal condition is assigned the coding level with the smallest of the Euclidean distance in the sparse constellation.

The disclosed technology can be implemented with a simple software/firmware update at the transmitter and the receiver side. The software/firmware update is required at the module that handles the physical layer processing of the transmitter and receiver chains and is typically the modem in the baseband chip (or SOC—system on chip) in the current digital implementations of the wireless receivers and transmitters including mobile phones, 4G/5G/6G small cells, macro 4G/5G/6G base stations, WiFi access points, WiFi clients, fixed wireless receivers and transmitters (operating in point-to-point or point-to-multipoint modes), IoT devices, satellite radio systems and satellite transceiver dishes used for broadband communication, CMTS and CMs, etc. Basically any wireless or wireline system that uses multiple access technology (i.e. multiple communication terminals communicating simultaneously) can use the proposed software/firmware updates to boost the capacity of the communication system. Depending on whether legacy devices are present in the communication system or not, implementation of the software/firmware can happen in multiple ways.

For example, if the communication system is a new system with no existing or legacy devices (including transmitters and receivers) without the disclosed technology, then all the devices can take advantage of an increase in the capacity boost by using the disclosed technology from the day the communication network starts the operations as the transmitters and receivers can be pre-configured with disclosed technology required software/firmware updates before deployment.

In another scenario, a communication system may already be operational with active transmitters and receivers. In this scenario, all the transmitters (e.g. 4G/5G/6G macro eNB, 4G/5G/6G small cell eNB, WiFi Access points, Satellite transmitters, high altitude platform (HAP) transmitters, fixed wireless access points (Point to multipoint), Docsis 3.1 CMTS and CMs etc. can be configured with the required disclosed technology's software/firmware updates during a planned maintenance window which is typically picked during the time of the day with lowest amount of network traffic to minimize the impact on user experience. For the receivers (4G/5G/6G mobile phones or fixed CPEs, WiFi terminals, satellite dish receivers on the ground, etc.), two approaches can be taken to update the required disclosed technology's software/firmware updates. First approach can be taken if it is not possible to update any of the legacy receivers (4G/5G/6G mobile phones or fixed CPEs, WiFi terminals/modems, satellite dish receivers on the ground, etc.) in the communication system. In the first approach, only the new receiver devices of the communication network can be pre-configured with required disclosed technology update before activation. Hence the transmitters that are already updated with disclosed technology software/update can select the legacy device for ONLY the constellation points of the shared constellation that has the largest Euclidean distance between the constellation points (i.e. lower MCS users. Example user 1 in the 2-user example described earlier in the current disclosure) that can be operated in the transparent mode (i.e. not aware of disclosed technology features and decode data in a normal manner) for the legacy devices and the new devices that are preconfigured with the disclosed technology's required software/firmware updates can be selected for any set of constellation points i.e. these devices can be assigned lower MCS users or MCS users of the shared constellation and are not restricted to ONLY lower MCS users like in case of legacy devices. Exact constellation points assigned to the new device depends on the other receiver device(s) it is paired with. For example, if two users (i.e. receivers) are paired and user with weak channel condition is a legacy device and user with the better channel condition is a new device with pre-configured disclosed technology's required software/firmware updates, then legacy device can be assigned constellation points of the shared constellation with highest Euclidean distance between the shared constellation and can operate in a transparent mode while the new device with better channel condition can be assigned the part of the shared constellation with lower Euclidean distance and can be instructed to decode the information using the disclosed technology as described earlier in the current disclosure. In another example, if 3 users (i.e. receivers) are grouped for transmission over shared constellation with legacy user with the weakest channel conditions and two new devices with pre-configured disclosed technology's required software/firmware updates in better channel conditions than the legacy device, then the legacy device can be assigned constellation points of the shared constellation with highest Euclidean distance between the shared constellation and can operate in a transparent mode while the two new devices can be assigned part of the shared constellation points with lower Euclidean distance and can be instructed to decode the information using the disclosed technology.

The proposed single shared constellation technique works only on a subset of constellation points of standard digital modulation schemes that are already implemented in the legacy systems and hence the transmitters and receivers have already gone through extensive testing to ensure that EVMs (error vector magnitude) and other RF parameters are within the maximum allowable limit. Hence no additional RF testing is needed to implement the technology in the existing and future communication units as the proposed innovation does not introduce any new modulation symbol constellation point for transmission or reception. Hence no hardware changes are needed.

Modified Algorithm: It may be possible to not select the closest constellation points of the current higher order constellation centered around the lower order constellation points and select the points that are not closest to the constellation points of the lower order constellation in order to improve the performance (due to increased Euclidean distance separation) of the higher order constellation point for the stronger channel user.

It is also possible to pick higher order user constellation points in such a way that avg. energy of the single shared constellation point is higher than 1 or reference avg. energy used for the standard constellation and the minimum intra-bit distance for the lowest order user is similar (approx. same) or higher than the minimum intra-bit distance for the lowest order user in the standard constellation of the lowest order user.

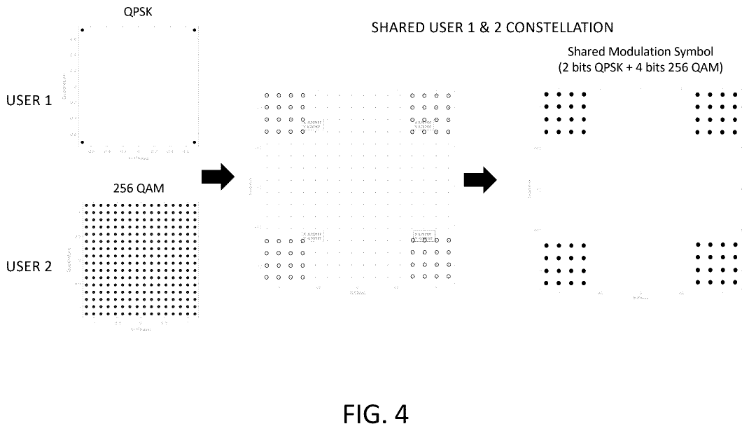

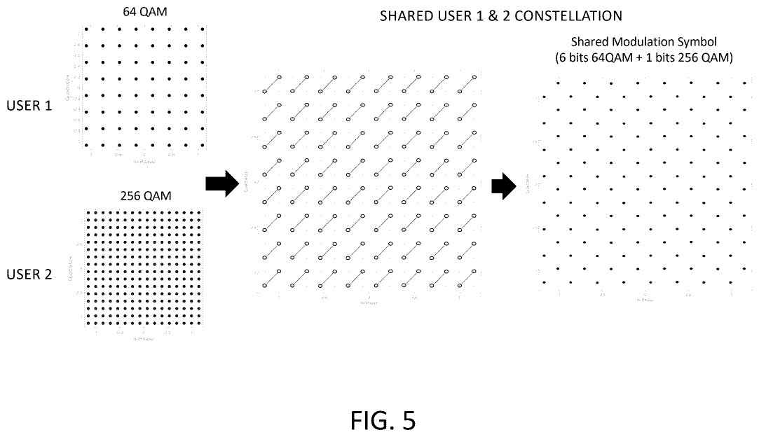

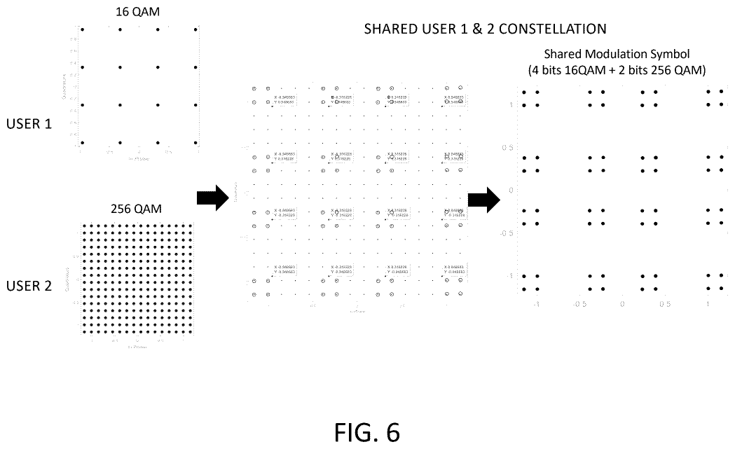

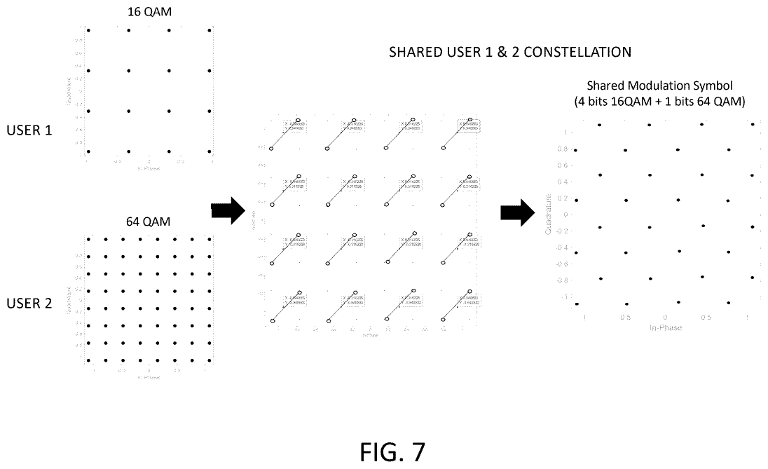

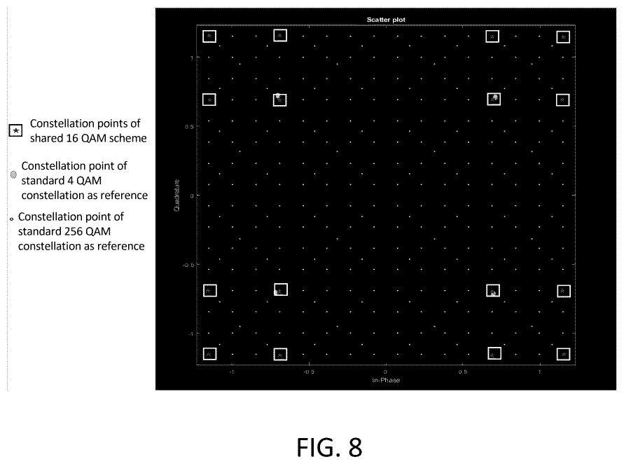

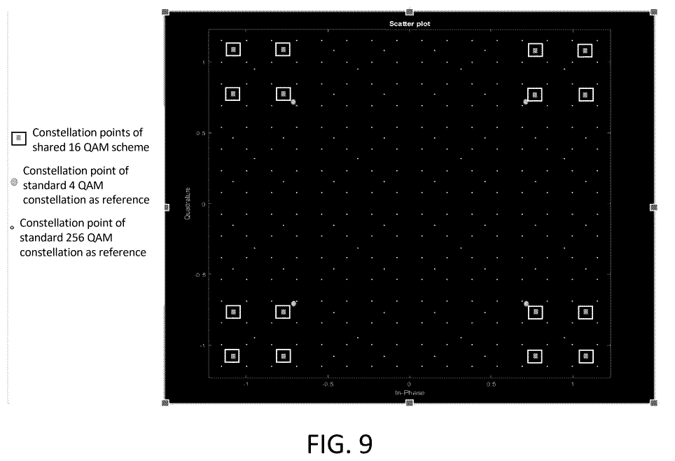

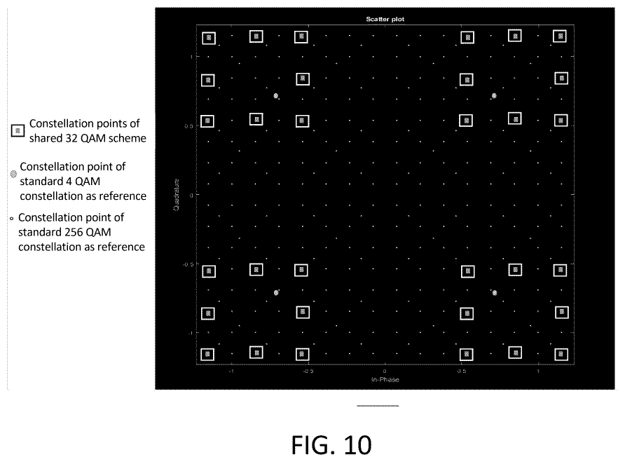

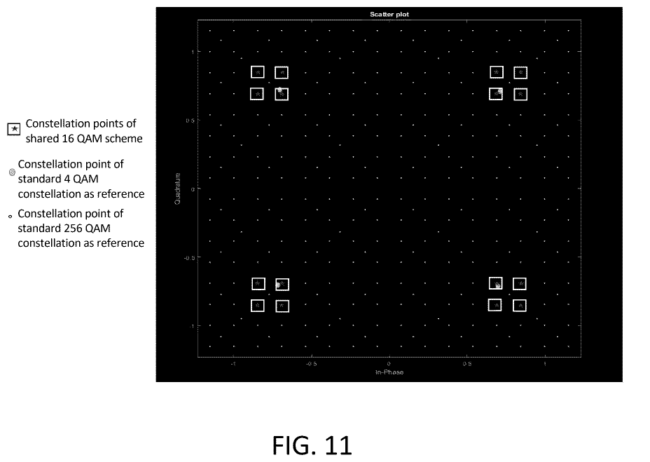

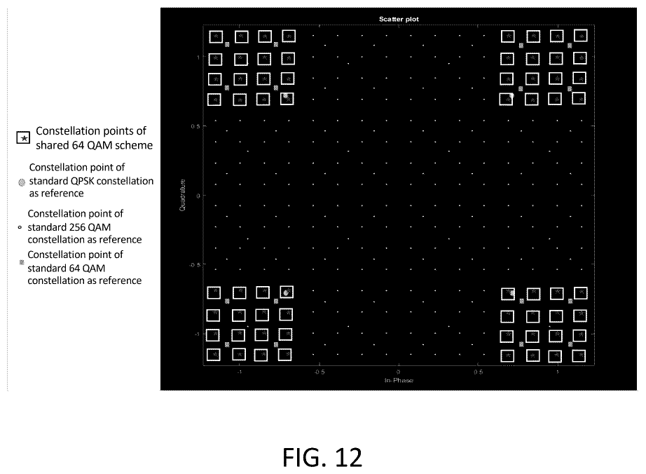

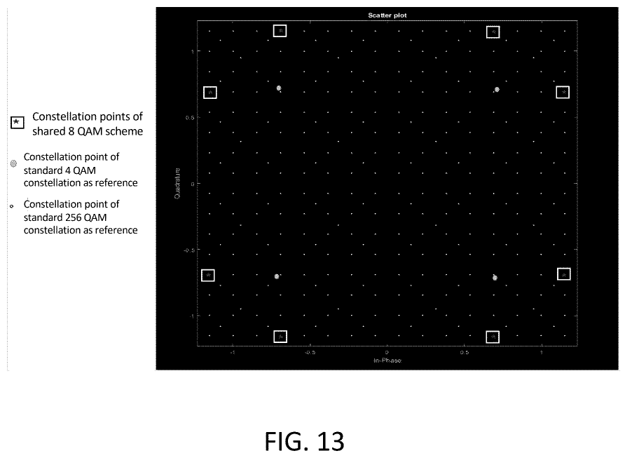

Using the principles disclosed herein, various combinations of shared constellations can be designed for two and more users. Some specific shared constellations designed according to the principles of the disclosed technology are as follows:
QPSK+256 QAM: Two users are paired for a joint transmission using the disclosed technology in this configuration. User 1 uses 4 QAM under regular operation, and user 2 uses 256 QAM under regular operation. In this shared modulation constellation configuration, a 64 QAM constellation which is a subset of the standard 256 QAM constellation, is transmitted carrying 6 bits per symbol. In this shared 64 QAM BOMA constellation, 2 bits per symbol is transmitted for user 1, and 4 bits per symbol is transmitted for user 2. The shared 64 QAM constellation is shown in FIG. 4.
64 QAM+256 QAM: Two users are paired for a joint transmission using the disclosed technology in this configuration. User 1 uses 64 QAM under regular operation, and user 2 uses 256 QAM under regular operation. In this shared modulation constellation configuration, a 128 QAM constellation which is a subset of the standard 256 QAM constellation, is transmitted carrying 7 bits per symbol. In this shared 128 QAM constellation, 6 bits per symbol is transmitted for user 1, and 1 bit per symbol is transmitted for user 2. The shared 128 QAM constellation is shown in FIG. 5.
16 QAM+256 QAM: Two users are paired for a joint transmission using the disclosed technology in this configuration. User 1 uses 16 QAM under regular operation, and user 2 uses 256 QAM under regular operation. In this shared modulation constellation configuration, a 64 QAM constellation which is a subset of the standard 256 QAM constellation, is transmitted carrying 6 bits per symbol. In this shared 64 QAM constellation, 4 bits per symbol is transmitted for user 1, and 2 bits per symbol is transmitted for user 2. The shared 64 QAM constellation is shown in FIG. 6.
16 QAM+64 QAM: Two users are paired for a joint transmission using the disclosed technology in this configuration. User 1 uses 16 QAM under regular operation, and user 2 uses 64 QAM under regular operation. In this shared modulation constellation configuration, a 32 QAM constellation which is a subset of the standard 64 QAM constellation, is transmitted carrying 5 bits per symbol. In this shared 32 QAM constellation, 4 bits per symbol is transmitted for user 1, and 1 bit per symbol is transmitted for user 2. The shared 32 QAM constellation is shown in FIG. 7.
QPSK+16 QAM: Two users are paired for a joint transmission using the disclosed technology in this configuration. User 1 uses QPSK under regular operation, and user 2 uses 16 QAM under regular operation. In this shared modulation constellation configuration, a 16 QAM constellation which is a subset of the standard 256 QAM constellation, is transmitted carrying 4 bits per symbol. In this shared 16 QAM constellation, 2 bits per symbol is transmitted for user 1, and 2 bits per symbol is transmitted for user 2. The shared 16 QAM constellation is shown in FIG. 8.
QPSK+64 QAM: Two users are paired for a joint transmission using the disclosed technology in this configuration. User 1 uses QPSK under regular operation, and user 2 uses 64 QAM under regular operation. In this shared modulation constellation configuration, a 16 QAM constellation which is a subset of the standard 64 QAM constellation, is transmitted carrying 4 bits per symbol. In this shared 16 QAM constellation, 2 bits per symbol is transmitted for user 1, and 2 bits per symbol is transmitted for user 2. The shared 16 QAM constellation is shown in FIG. 9.
QPSK+64/256 QAM: Two users are paired for a joint transmission using the disclosed technology in this configuration. User 1 uses QPSK under regular operation, and user 2 uses 64/256 QAM under regular operation. In this shared modulation constellation configuration, a 32 QAM constellation which is a subset of the standard 256 QAM constellation, is transmitted carrying 5 bits per symbol. In this shared 32 QAM constellation, 2 bits per symbol is transmitted for user 1, and 3 bits per symbol is transmitted for user 2. The shared 16 QAM constellation is shown in FIG. 10.
QPSK+256 QAM: Two users are paired for a joint transmission using the disclosed technology in this configuration. User 1 uses QPSK under regular operation, and user 2 uses 256 QAM under regular operation. In this shared modulation constellation configuration, a 16 QAM constellation which is a subset of the standard 256 QAM constellation, is transmitted carrying 4 bits per symbol. In this shared 16 QAM constellation, 2 bits per symbol is transmitted for user 1, and 2 bits per symbol is transmitted for user 2. The shared 16 QAM constellation is shown in FIG. 11.
QPSK+64QAM+256QAM: Three users are grouped for a joint transmission using the disclosed technology in this configuration. User 1 uses QPSK under regular operation, user 2 uses 64QAM under regular operation and user 3 uses 256 QAM under regular operation. In this shared modulation constellation configuration, a 64 QAM constellation which is a subset of the standard 256 QAM constellation, is transmitted carrying 6 bits per symbol. In this shared 64 QAM constellation, 2 bits per symbol is transmitted for user 1, user 2 and user 3. The shared 64 QAM constellation is shown in FIG. 12.
QPSK+164QAM: Two users are paired for a joint transmission using the disclosed technology in this configuration. User 1 uses QPSK under regular operation, and user 2 uses 16 QAM under regular operation. In this shared modulation constellation configuration, an 8 QAM constellation which is a subset of the standard 256 QAM constellation, is transmitted carrying 3 bits per symbol. In this shared 8 QAM constellation, 2 bits per symbol is transmitted for user 1, and 1 bit per symbol is transmitted for user 2. The shared 8 QAM constellation is shown in FIG. 13.

In the present disclosure, the final shared constellation can be a subset of constellation points of the user with highest MCS under the normal operation (i.e. the strongest channel user). In another embodiment, the final shared transmitted constellation can also be a subset of a standard constellation that is higher order than the constellation order of the user with highest MCS. For example, in one embodiment, if a user 1 is paired with a user 2 where user 1 uses the standard QPSK under normal operation and user 2 uses 256 QAM under normal operation then in one embodiment, the final shared constellation that is transmitted can be a subset of constellation points of the standard 256 QAM constellation. In another embodiment, the final shared constellation that is transmitted can be a subset of constellation points of the standard constellation higher than the standard 256 QAM constellation such as 512 QAM, 1024 QAM, 2048 QAM, 4096 QAM and so on and designed based on the principles disclosed herein.

Although the disclosed technology has been described with reference to specific embodiments, other embodiments may occur to those skilled in the art without deviating from the intended scope. Hence it is to be understood that general families of embodiments are contemplated and that the invention is to be limited by the scope and spirit of the appended claims.

What is claimed is:

1. A communication system for transmitting data between multiple communication nodes in a network, comprising:
a plurality of communication nodes configured to operate in at least one mode selected from a group consisting of point-to-multipoint, multipoint-to-point, and multipoint-to-multipoint modes, wherein each communication node is capable of acting as a transmitter, a receiver, or both;
a modulation and coding scheme (MCS) selection module in each communication node configured to dynamically adapt modulation schemes and coding rates based on channel conditions between the transmitting and receiving nodes to achieve a target transmission error rate; and
a shared modulation constellation scheme configured to enable the transmission of data streams for at least two users with different MCS indexes by grouping their data into a single shared modulation symbol, wherein:
the shared modulation constellation scheme comprises a subset of constellation points derived from a higher-order standard modulation constellation associated with a higher MCS index user, and
the subset of constellation points is selected based on the Euclidean distance to standard constellation points associated with a lower MCS index user to maximize signal separation;
wherein the shared modulation constellation scheme enables simultaneous transmission of data for multiple users with distinct channel conditions, reducing power per bit and increasing data throughput over the network.

2. A method for transmitting data in a communication network comprising multiple communication nodes, each configured as a transmitter, receiver, or both, wherein the method comprises:
operating the communication network in one or more of the following modes: point-to-multipoint, multipoint-to-point, or multipoint-to-multipoint;
selecting an MCS for each transmitting node based on real-time channel conditions between the transmitting node and receiving node to meet a target error rate;
grouping data streams from a plurality of users, wherein each user is associated with a different MCS and modulation order, by:
creating a shared modulation constellation symbol that includes a subset of constellation points from a higher-order modulation constellation associated with a higher MCS user, and
selecting said subset based on the Euclidean distance from points in a lower-order modulation constellation associated with a lower MCS user, ensuring optimal separation of constellation points;
transmitting the shared modulation constellation symbol from a transmitter to one or more receivers, wherein the shared modulation constellation symbol carries distinct data streams for each user based on their respective MCS; and
decoding the shared modulation constellation symbol at each receiving node to retrieve the corresponding data for each user, thereby achieving enhanced data throughput and power efficiency in the communication network.

3. A digital communication device capable of transmitting and receiving data in a shared modulation constellation format, comprising:
a transceiver operable in point-to-multipoint, multipoint-to-point, and multipoint-to-multipoint modes within a communication network;
a modulation selection unit configured to adjust modulation schemes in real-time based on channel conditions to meet a predefined target error rate, wherein the modulation scheme is selected from a group including BPSK, QAM, and PSK;
a shared modulation module configured to:
aggregate data streams from multiple users with differing MCS indexes into a single shared modulation symbol,
determine an optimal subset of higher-order constellation points based on proximity to a lower-order constellation associated with a user of lower MCS, and
assign each user in the shared modulation symbol with a unique subset of bits, such that each bit subset corresponds to a distinct portion of the constellation symbol; and
a decoding module configured to decode each received shared modulation symbol, separating the bits for each user and applying respective coding schemes to retrieve the data streams;
wherein the shared modulation symbol improves data throughput, minimizes power consumption, and optimizes spectral efficiency in the communication network.
